(19) United States
(12) Patent Application Publication
(10) Pub. No.: US 2003/0033165 A1
(43) Pub. Date: Feb. 13, 2003

(54) Environmental service system and environmental service business

(76) Inventors: Kazuhiko Inoue, Yokohama (JP); Kenji Tojo, Moriya (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/212,245

(22) Filed: Aug. 6, 2002

(30) Foreign Application Priority Data
Aug. 10, 2001 (JP) 2001-244195

(51) Int. Cl. G06F 17/60

(52) U.S. Cl. 705/1; 705/7

(57) ABSTRACT

An environmental service business-entity designs at least one of a unit for heating a space or target space higher than an outside-air temperature and a unit for cooling the target space lower than an outside-air temperature, the target space having been defined between the business-entity and a client. The business-entity guarantees that the quality of environment including the temperature of the target space will be maintained in a range determined in consultation with the client. This condition substantially guarantees the total cost that results from assessing both an initial cost and a running cost. Accordingly, the user finds it easier to introduce an environmental facility without risk.

### BACKGROUND OF THE INVENTION

The present invention relates to an environmental service system. More concretely, it relates to environmental technologies for maintaining an environment, e.g., a preserving environment for foods, a living environment for humans, or the other environment such as a setting-up environment for products, at a comfortable environment whose temperature, humidity, degree of cleanliness, and the like are desired ones.

Using an air-conditioning facility or the like, a living space for humans in an office, a store, a house, or the like is adjusted to an environment whose temperature, humidity, degree of cleanliness, and the like are desired ones. Also, the increasing number of foods are now placed on the distribution processes in a state of being refrigerated or frozen, then being stored into a refrigerating showcase, a freezing showcase, or the like so as to be preserved and sold. Moreover, it is requested that, of electronic appliances and medical supplies, some types of products should be manufactured and used in an environment whose temperature, humidity, degree of cleanliness, and the like are predetermined ones.

In order to implement the desired conditions of an environment as described above (which, hereinafter, will be referred to as “the quality of environment), there are provided the following environmental facilities: An air-conditioning facility with a cooling/heating function, a freezing facility, a refrigerating facility, a dust-removing facility like a filter, and a deodorizing facility using ozone or the like. In general, the architecture business-entity of an office building or a store becomes the general constructor of these environmental facilities. Moreover, taking into consideration requests from the client, i.e., the user, the specifications and the maker of the environmental facilities are determined. In this case, the sales form of the environmental facilities has been established as follows: When the environmental-facility maker has completed the installing instructions and the trial runs, the relation with the client is terminated except for the response to a breakdown or the like.

### SUMMARY OF THE INVENTION

In the case of employing the sales form mentioned above, the judgement criterion for determining the specifications of the environmental facilities becomes likely to depend on the initial cost (i.e., facility investment expense). Accordingly, there exists a tendency to underestimate the importance of the running cost (i.e., operation expenses such as utility bill or electric-power bill) after the setting-up. As a consequence, if, e.g., a constant-speed type compressor is selected as the compressor of a refrigerant, the control over the freezing capability or the like is basically performed by the ON/OFF with respect to a variation in the outside-air temperature of the constant-speed type compressor. This condition sets a limit to an enhancement in the energy efficiency, thereby making the running cost (i.e., electric-power bill) become likely to get higher. In contrast to this, if a variable-speed type compressor using an inverter is selected, the energy efficiency is higher as compared with the constant-speed type compressor although the initial cost becomes higher. This condition makes it possible to reduce the running cost. As a result, the long-term use of the variable-speed type compressor also makes it possible to recover the difference from the initial costs.

Meanwhile, the energy efficiency of a freezing cycle or a heat pump cycle, which constitutes the air-conditioning facility, the freezing facility, the refrigerating facility, and the like, undergoes tremendous influences by the activation states of a heat exchanger and the refrigerant. For example, the long-term use of the heat exchanger between the air and the refrigerant tends to contaminate the air side of the heat-transmitting tube. This extremely lowers the heat exchange efficiency. Consequently, the periodic washing of the heat exchanger allows the heat exchange efficiency to be maintained at a high level. Also, the appropriate control over the activation state, e.g., the pressure of the refrigerant, makes it possible to enhance the energy efficiency of the freezing cycle or the heat pump cycle. For these reasons, it is being practiced that an environmental-facility maker designs a remote-monitoring/maintenance system for the air-conditioning facility, the freezing facility, the refrigerating facility, and the like and proposes the user that it commit or entrust the maintenance/management of these environmental facilities to the environmental-facility maker itself or a service company related thereto.

By the way, the various attempts to improve the global warming are now being promoted on an international scale. For example, it is requested that energy-saving measures should be carried out. Under the background like this, the researches and developments that are now being promoted are as follows: The research and development of energy-saving appliances, those of energy-saving facilities, and those of the energy-saving measures based on the driving methods and the managing methods.

Meanwhile, the user, i.e., the client, would strongly promote an energy-saving measure if an initial cost for carrying out this energy-saving measure could be surely recovered by a running cost that can be reduced by the energy-saving.

With the conventional sales form or manner of the environmental facilities, however, the user is rather reluctant to adopt the energy-saving measure unless it is guaranteed that the total cost can be decreased without fail, no matter how it appears reasonable to choose the environmental-facility specifications when both of the initial cost and the running cost are evaluated together, as a whole.

Also, if it would be understandable that the periodic checking, maintenance, and the like of the environmental facilities allow the energy efficiency to be maintained at a high level, thereby making it possible to decrease the running cost, the user would not make a decision to commit or entrust the maintenance/management of the environmental facilities to an environmental service company or the like, unless such is guaranteed.

In view of the actual situation concerning the conventional sales form and maintenance/management of the environmental facilities, an object of the present invention is to make it easier to introduce an environmental facility that allows the implementation of a contribution to an energy-saving or the like.

The present invention founds and establishes the following environmental service business, thereby accomplishing the above-described object.

An environmental service business-entity designs at least one of the following environmental facilities: A unit for heating a space (i.e., target space) higher than an outside-air temperature and a unit for cooling the target space lower than an outside-air temperature, the target space having been defined between the business-entity and a client. Moreover, the business-entity guarantees that the quality of environment, including the temperature of the target space, will be maintained in a range determined in consultation with the client. This condition substantially guarantees the total cost derived by assessing both an initial cost and a running cost together, making it easier for the user to introduce an environmental facility that meets such requests as an energy-saving without risk. As a result, the user can make a contribution to the suppression of the global warming.

In this case, it is preferable that the environmental service business-entity receive a part of the reduction in the running cost obtained by the energy-saving effect of the environmental facility as a consideration for the guarantee. At this time, it is also preferable that, depending on the amount of the consideration, the environmental service business-entity perform the following: Collecting measurement data on the quality of environment of the target space and working state data on the environmental facility, and performing, within the range of the consideration, the maintenance/management necessary for maintaining the quality of environment in the range determined in consultation with the client. Namely, since the running cost for maintaining the quality of environment varies greatly by the management (e.g., monitoring, checking, maintenance, and repairing) of the environmental facility or the like, the checking and the maintenance are absolutely necessary for guaranteeing the running cost. Incidentally, by entrusting the management to the environmental service business-entity, the user can save a personnel expense and the like that are necessary for the management.

Concretely, the above-described environmental service business can be implemented by configuring the following environmental service system: The system includes at least one of a unit for heating a space higher than an outside-air temperature and a unit for cooling the space lower than an outside-air temperature, the space having been defined between the system and a client, the system maintaining the quality of environment including a temperature of the space in a range determined in consultation with the client, the system acquiring a consideration in correspondence with the maintained quality of environment.

In this case, the system may include the following units: A monitoring unit for monitoring the quality of environment including the temperature of the space, a control unit for controlling the heating unit or the cooling unit so as to adjust the quality of environment of the space on the basis of monitor information by the monitoring unit and a set-up value of the quality of environment of the space, and a calculating unit for judging, on the basis of the monitor information by the monitoring unit, whether or not the quality of environment of the space has been maintained in the range determined in consultation with the client, and for calculating the consideration in correspondence with the maintained quality of environment.

Also, if the set-up value of the quality of environment has been set up outside the range determined in consultation with the client, after a lapse of a constant time-period from the set-up, the control unit is capable of restoring the set-up value of the quality of environment back to within the range determined in consultation with the client.

Also, the consideration calculating unit, which is installed under the management of the environmental service business-entity, is connected to the monitoring unit in a communicable manner via a communications network.

Moreover, at least one of the monitoring unit, the heating unit, and the cooling unit can include a communications unit for collecting data on the quality of environment and operation states of the heating unit and the cooling unit so as to transmit the data to an information managing unit of the environmental service business-entity via the communications network.

Also, the information managing unit has a function of comparing the collected data on the quality of environment and on the operation states of the heating unit and the cooling unit with diagnosis data, and of making diagnosis of the heating unit and the cooling unit.

In substitution for the above-described environmental service system, the following environmental service system can be implemented: The system includes an electric-power generating unit and at least one of a unit for heating a target space and a unit for cooling the target space, the system maintaining the quality of environment including a temperature of the target space in a range determined in consultation with a client, the system acquiring a consideration in correspondence with the maintained quality of environment and an electric-power supply quantity from the electric-power generating unit. In this case, it is preferable that the heating unit and the cooling unit should utilize, as an energy source, a waste heat from the electric-power generating unit.

Here, based on a contract or the like, the above-described consideration can be defined as follows:

(1) It is determined in correspondence with a contracted temperature of the space and a performance record of the energy consumption.

(2) A basic rate for the consideration is determined based on a contracted temperature of the space and is increased or decreased in amount in correspondence with a difference between a set-up value set up, as required, by a client and the contracted value.

(3) It is determined in association with a size of the space and a range of a contracted temperature of the space.

(4) It is determined based on an energy bill (e.g., actual electric-power expense for one year) needed for maintaining the quality of environment of the space.

(5) If a set-up value of a temperature of the space has been set up outside a range determined in consultation with a client, it is increased or decreased in amount in correspondence with a difference between the set-up value and a contracted value.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for illustrating an embodiment of the business-operation flow associated with an environmental service business according to the present invention;

FIG. 2 is a diagram for illustrating a concept of the contract form between a client and an environmental service business-entity;

FIG. 3 is a diagram for illustrating an embodiment of an environmental service system to which the environmental service business according to the present invention has been applied;

FIG. 4 is a systematic configuration diagram of an air-conditioning facility in FIG. 3;

FIG. 5 is a systematic configuration diagram of a freezing or refrigerating showcase in FIG. 3; and

FIG. 6 is a system configuration diagram of a combined electric-power generating facility in FIG. 3.

### DESCRIPTION OF THE EMBODIMENTS

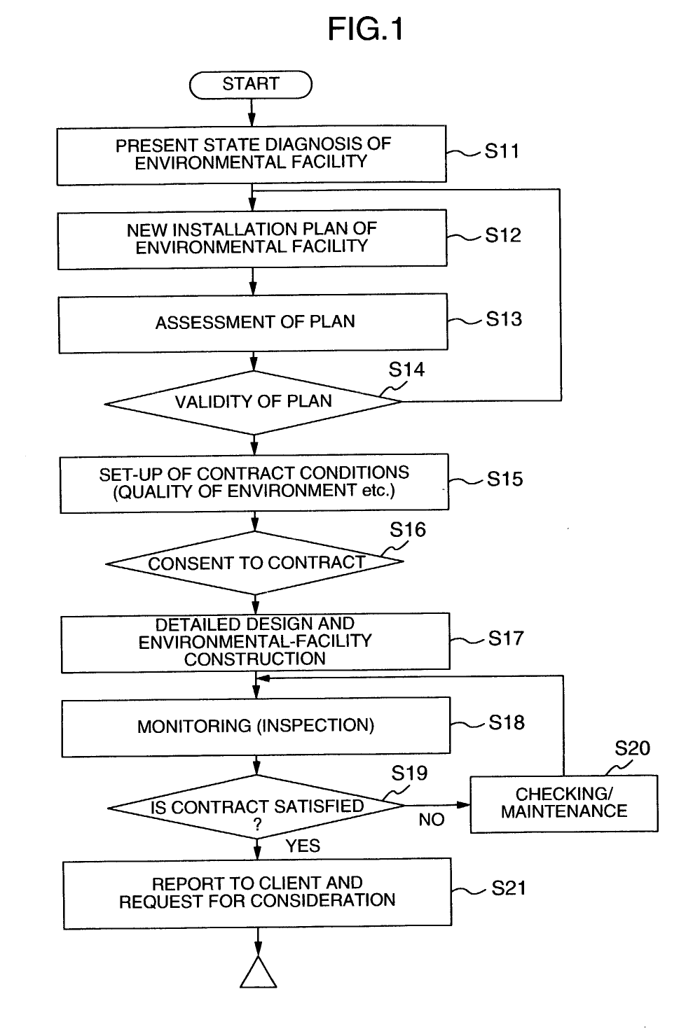

Hereinafter, explanation will be given below concerning embodiments of an environmental service business according to the present invention. FIG. 1 illustrates an embodiment of the business-operation flow associated with the environmental service business.

(Step S11)

Responding to a request from a client, the business-operations of the environmental service start with the diagnosis of such factors as the energy-saving regarding an existing environmental facility or the like. In particular, when replacing the existing environmental facility by a new environmental facility, an investigation is conducted concerning such factors as the energy consumption quantity of the existing environmental facility, then accumulating such factors as past data. Here, the energy consumption quantity of the existing environmental facility varies depending on the operation time or the operation ratio, the weather (e.g., temperature and humidity), the season, the day or night, and the like. Accordingly, the past data on the energy consumption quantity is collected in a state where these pieces of attribute data are attached thereto and over the longest possible time-period available. This past data becomes a criterion at the time of calculating the quality of environment and the energy-saving effect corresponding to the quality of environment.

(Step S12)

Next, focusing on an energy-saving measure, a plan on the new environmental facility is devised. At the beginning of the plan, the following fundamental conditions are set up: The installation space of the new environmental facility, the investment amount, the contracted electric-power, the depreciation years, and the future add-on installation plan or expanding plan. Also, in the new environmental facility, the quality of environment (e.g., temperature, humidity, degree of cleanliness, and the like) of a space selected as the target, such as a living space and a preserving space for foods, is set up.

Also, as the energy-saving measure, proposals are made concerning the employment of an energy-saving appliance, the installation of an energy-saving facility, and such maintenance/management, facility operation, or the like as enhancing the energy-saving effect. For example, if the driving motor of a refrigerant compressor in an existing air-conditioning facility or freezing facility is a constant-speed type motor, the control of this motor is converted into an inverter control. Then, the rotation number of this motor is controlled in harmony with a variation in the freezing load, thereby implementing the energy-saving.

Also, for example, the pattern of the electric-power consumption quantity and that of the thermal-energy consumption quantity of the existing environmental facility on a daily basis are investigated based on the past data created at the step S11. Then, if the electric-power consumption quantity at night is found to be very small as compared with that in the daytime, the energy is stored at night using an ice thermal storage type system, a thermal storage apparatus, or the like. Next, the stored energy is released in the daytime so as to implement the averaging or leveling of the daytime electric-power and the night one, thereby reducing the electric-power expense. Furthermore, the introduction of an energy-saving facility, which, like a combined electric-power generating apparatus (i.e., co-generator), generates electric-power and heat by burning a fuel such as an oil or a gas, is also under consideration.

In this way, after planning a concrete energy-saving measure, the reduction effect on the energy consumption quantity in the case of carrying out the concrete energy-saving measure is calculated on trial.

(Step S13)

Here, the validity of the plan is assessed. In this assessment, not only when newly installing an environmental facility but also when replacing an existing environmental facility by a new one, the economical assessment is performed in the summation of an initial cost and a running cost of the planned environmental facility, i.e., the total cost thereof. The initial cost is the installation expense of the environmental facility. The running cost includes taxes or the like imposed on the environmental facility, the operating expense such as the electric-power bill, the maintenance/checking expense, and other expenses such as the personnel expense. The assessment is performed concerning, in particular, the reduction effect on the running cost by the energy-saving or the like. Since the energy expense of the environmental facility is influenced greatly by the weather and the operation ratio of the facility, the electric-power bill and the other energy expenses are calculated by taking these items into consideration. Incidentally, in the case of the new installation, the assessment is performed using data obtained by calculating the energy consumption quantity of an environmental facility of the comparison target in accordance with the characteristic data on the facility appliance.

Moreover, for example, various expenses such as an initial investment, taxes, and a personnel expense, which are necessary for the new installation of the environmental facility, are assessed by calculating on trial basis how many years it will take to recover the various expenses by the reduction amount of the running cost by the energy-saving effect. Incidentally, the initial cost of the environmental facility, whether the user pays it by a single payment or the environmental service business-entity leases or lends the facility, become the same amount if the initial cost is converted into a single-year depreciation expense.

In this way, the comparison is made between the total cost needed for the planned environmental facility and the total cost needed for the existing environmental facility and the assessment is performed by, for example, calculating on trial basis how many years it will take for depreciation.

(Step S14)

If no validity of the plan exists, the plan is cancelled, or going back to the step S12, the conditions are modified so as to reconsider the plan again. If there exists validity or feasibility of the plan, the business-operation goes to the following steps:

(Step S15)

If the plan is assessed to be valid, the client and the environmental service business-entity set up contract conditions as described below, confirming that guaranteeing the quality of environment is the basic condition.

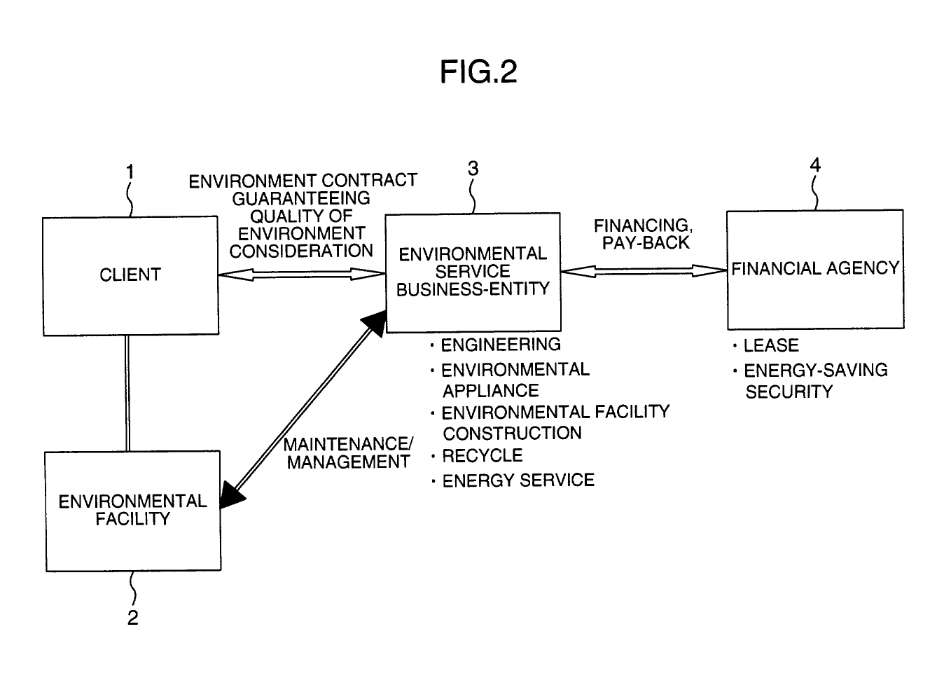

At first, as an example, a contract form as illustrated in FIG. 2 is employed. As illustrated in the drawing, the contract form can be as follows: An environmental facility 2 installed inside an accommodation of a client 1 is assumed to be a resource of an environmental service business-entity 3, and thus the environmental facility 2 is lent to the client 1. In this case, the contract form is such that the installation expense (i.e., initial cost) of the environmental facility 2 is borne by the environmental service business-entity 3. Consequently, the environmental service business-entity 3 needs to obtain a financing of the investment expense from a financial agency 4 or make a lease contract, in the meantime, to receive, from the client 1, the payment of an amount that is commensurate with the lease fee and the like (i.e., financing pay-back amount +tax, and others), as required.

The present embodiment features that the environmental service business-entity 3 is paid the consideration which includes a reward determined in correspondence with the quality of environment added to the above-described amount that is commensurate with the lease fee and the like as a basic rate. Namely, if the running cost could be reduced by the energy-saving effect, the total cost is lowered even if the initial cost is rather high. This makes it possible to lower the single-year total expense. In the conventional contract form (i.e., so-called “sell”), this reduced amount in the total expense goes back to the client 1 all. In contrast to this, the present embodiment feature that the consideration like the concept of the success fee system is stipulated in the contract. Concretely, this success fee concept is implemented by a condition that the environmental service business-entity 3 substantially guarantees the total cost about the environmental facility in order to make it easier for the client 1 to introduce an energy-saving type environmental facility. Namely, the environmental service business is one where, ultimately, the quality of environment is the target of the service. Consequently, the client will be satisfied as long as the quality of environment is satisfactory enough and the total expense on a single-year basis falls within a constant range.

Thus, the reduced amount in the total expense by the energy-saving effect is distributed between the client 1 and the environmental service business-entity 3 with a constant proportion, thereby making it possible to guarantee the quality of environment. Concretely, on the premise that the condition stipulated in the contract with respect to the quality of environment will be satisfied, the amount of the consideration is determined in correspondence with the quality of environment of a space selected as the target. By using the consideration as the income, the environmental service business-entity 3 operates the business. For example, the business-entity 3 spends the consideration on the pay-back or acquittal of the financing or the lease fee obtained from the financial agency 4 and in the meantime, earmarks it for the maintenance/management (e.g., inspection, maintenance, and improvement) of the energy-saving facility.

Incidentally, although the consideration is determined using the quality of environment employed as the criterion, other variation factors exerting influences on the energy-saving effect, such as the operation time or the operation ratio of the environmental facility, may be taken into consideration.

(Step S16)

If both of the parties reach agreement based on the contract conditions at the step S15, the parties establish a contract regarding the facility construction for the replacement or the new installation of the environmental facility and the maintenance/management thereof.

(Step S17)

Based on the contract, the environmental service business-entity 3 or an agency related thereto performs a detailed design of the environmental facility including the energy-saving measure, and carry out the construction.

(Step S18)

After carrying out the installation of the new environmental facility, the environmental service business-entity 3 monitors the operating state of the environmental facility, thus measuring and recording periodically (e.g., on a 15-minute to 1-hour basis) data on the temperature, the humidity, and the like about the quality of environment of the target space stipulated in the contract.

Also, the environmental service business-entity 3 performs the collection of the operation data such as the energy consumption quantity, and the maintenance/management business-operations such as the presence or absence of a failure, the carrying-out of the maintenance, and further the repairing/improvement. For example, the business-entity periodically measures the energy consumption quantity or data necessary for calculating the energy consumption quantity, e.g., the electric voltage, the electric current, the flow quantity of the fuel, the flow quantity of a fluid such as the refrigerant, and the temperature, then recording the energy consumption quantity or the data as measurement data. At this time, the business-entity simultaneously measures the attribute data such as the temperature and the humidity of the outside air, then recording the attribute data in a state of being attached to the measurement data such as the energy consumption quantity. Moreover, the business-entity makes a comparison between the measurement data and the past data, which has been stored in the database, in the attribute data that are identical or become substantially identical to each other, thereby calculating an energy reduction quantity. If there exists none of the attribute data that are identical or become substantially identical to each other, the business-entity approximates the energy reduction quantity by using an interpolation method or an extrapolation method. Furthermore, based on the energy reduction quantity calculated and an energy unit-price defined in the contract, the business-entity computes a reduced amount in the energy expense.

(Step S19)

The environmental service business-entity 3 judges whether or not the recorded quality of environment satisfies a guarantee value defined in the contract. Also, the business-entity judges whether or not the reduced amount calculated at the step S18 satisfies the criterion determined for the consideration for the quality of environment. The business-operation goes to a step S20 if this judgement is found to be negative, and proceeds to a step S21 if this judgement is found to be affirmative.

(Step S20)

If the quality of environment is found to be lower than the guarantee value, the environmental service business-entity 3 analyzes its cause on the basis of the collected operating data, then performing the maintenance or the improvement of the environmental facility so that the quality of environment will satisfy the guarantee value. The expense needed for the maintenance or the improvement, basically, can be included within the range of the consideration defined in the contract. For this purpose, the business-entity appropriately monitors the measurement data of the environmental facility so as to judge whether or not each appliance is exhibiting a predetermined performance, then carrying out the maintenance or the like as required. This permits the business-entity to manage the environmental facility in such a manner that the subsidiary or incidental conditions, such as the guarantee value of the quality of environment and the energy-saving effect, will be satisfied.

(Step S21)

If, in the judgement at the step S19, the contract is found to be satisfied, the environmental service business-entity 3 periodically (e.g., on a 1-month basis, or a 3 to 12-month basis) sums up the consideration. Simultaneously, the business-entity reports the quality of environment and the energy-saving effect to the client, thereby requesting the payment of the consideration.

As having been explained so far, according to the environmental service business method illustrated in FIG. 1, it becomes possible to acquire the guarantee that the initial cost and the running cost can be decreased without fail. This condition makes it easier for the client to introduce the environmental facility that can make a contribution to the suppression of the global warming by the energy-saving.

In particular, it is guaranteed to maintain the quality of environment, and the client pays the consideration that is commensurate with the guarantee. This condition allows the client to commit or entrust the maintenance/management of the environmental facility to the environmental service business-entity, thereby permitting the client to save the personnel expense and the like which are necessary for the maintenance/management.

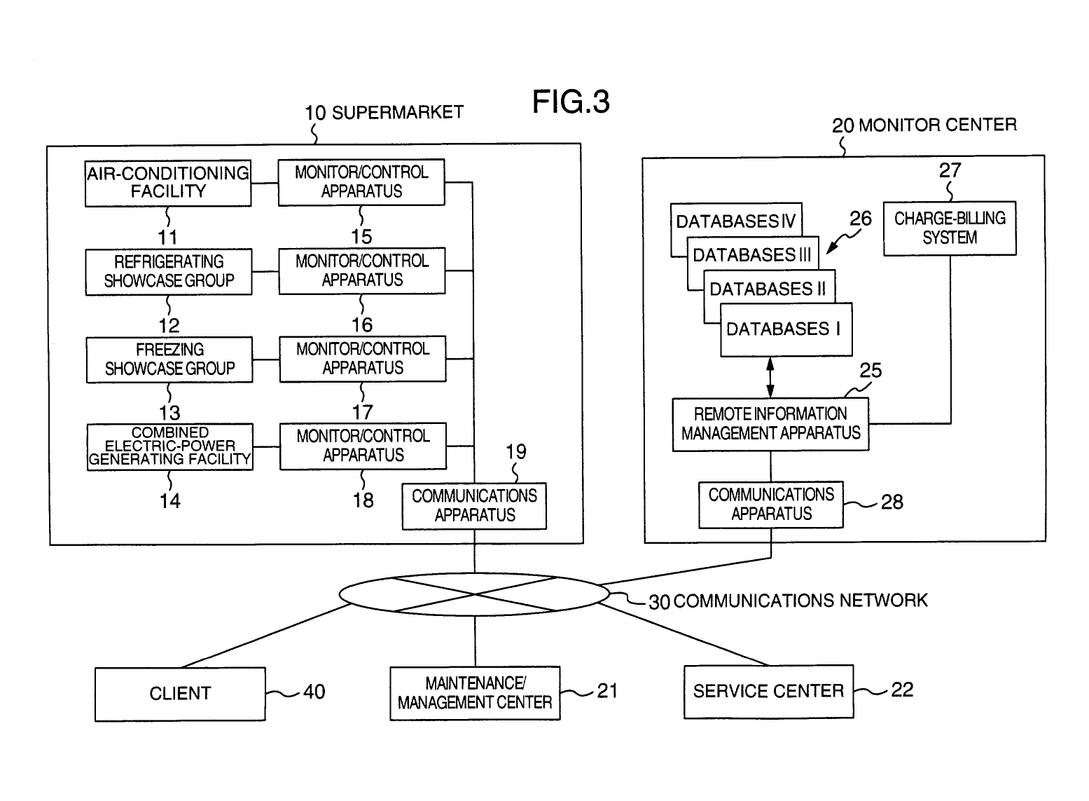

FIG. 3 illustrates an embodiment of an environmental service system to which the environmental service business in FIG. 1 has been applied. The present embodiment is an environmental service system the target of which is environmental facilities provided in a supermarket that has a food department. In the supermarket 10, there are provided the following environmental facilities: An air-conditioning facility 11 for adjusting the environment of a living space for humans, a food-refrigerating showcase group 12, and a food-freezing showcase group 13. Also, as required, there is provided a combined electric-power generating facility (i.e., co-generator) 14. Also, there are provided monitor/control apparatuses 15 to 18 that monitor and control these environmental facilities, respectively. The monitor/control apparatuses 15 to 18 are connected to a communications network 30 such as the Internet via a communications apparatus 19. Also, environmental facilities in a client 40 are similarly connected to the communications network 30 via a communications apparatus.

The environmental service business-entity has the following agencies related thereto: A monitor center 20, a maintenance/management center 21, a service center 22, and the like. The monitor center 20 includes a remote information management apparatus 25, databases 26, and a charge-billing system 27. The remote information management apparatus 25 is connected to the communications network 30 such as the Internet via a communications apparatus 28. This connection has formed the remote information management apparatus 25 such that the apparatus 25 can receive, from the communications network 30, state data such as operating data on the environmental facilities provided in the supermarket 10. Also, as required, the remote information management apparatus 25 can transmit a control instruction or the like to the monitor/control apparatuses 15 to 18 provided in the supermarket 10, and can transmit/receive information to/from the maintenance/management center 21 and the service center 22.

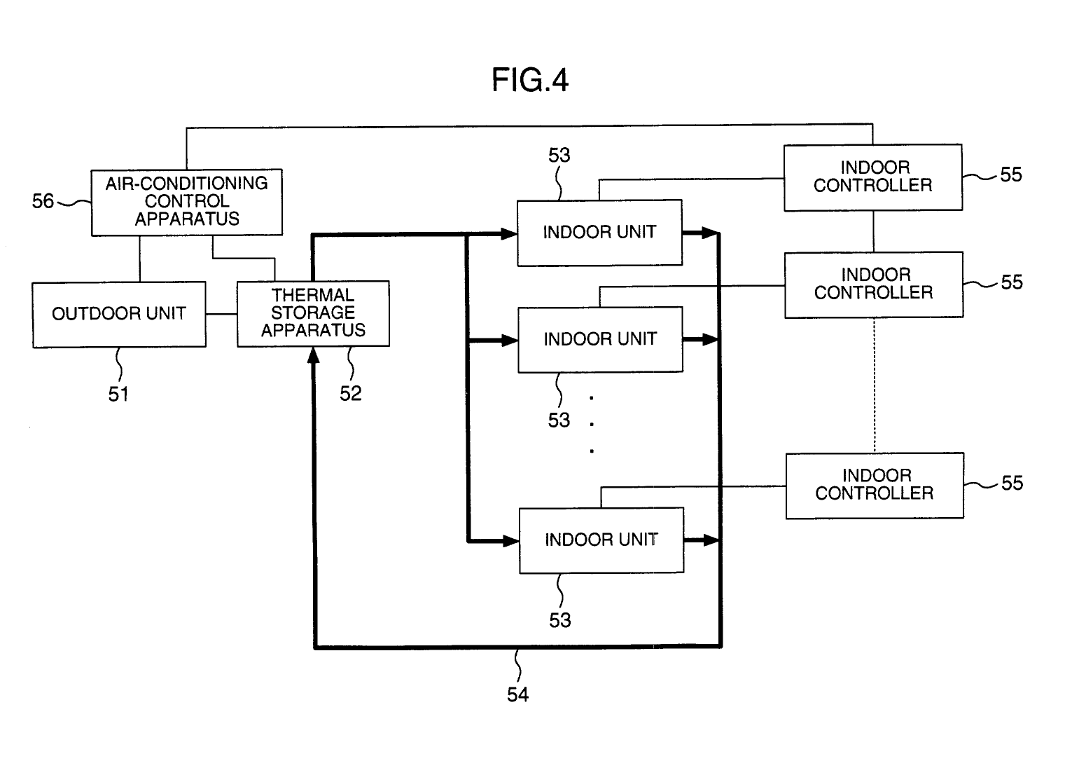

As illustrated in FIG. 4, the air-conditioning facility 11 includes an outdoor unit 51 including a freezing cycle and a heat pump cycle, a thermal storage apparatus 52, and a plurality of indoor units 53. A heat-transmitting fluid 54, e.g., a refrigerant or a hot water, is caused to circulate a heat exchanger of each indoor unit 53 via the thermal storage apparatus 52.

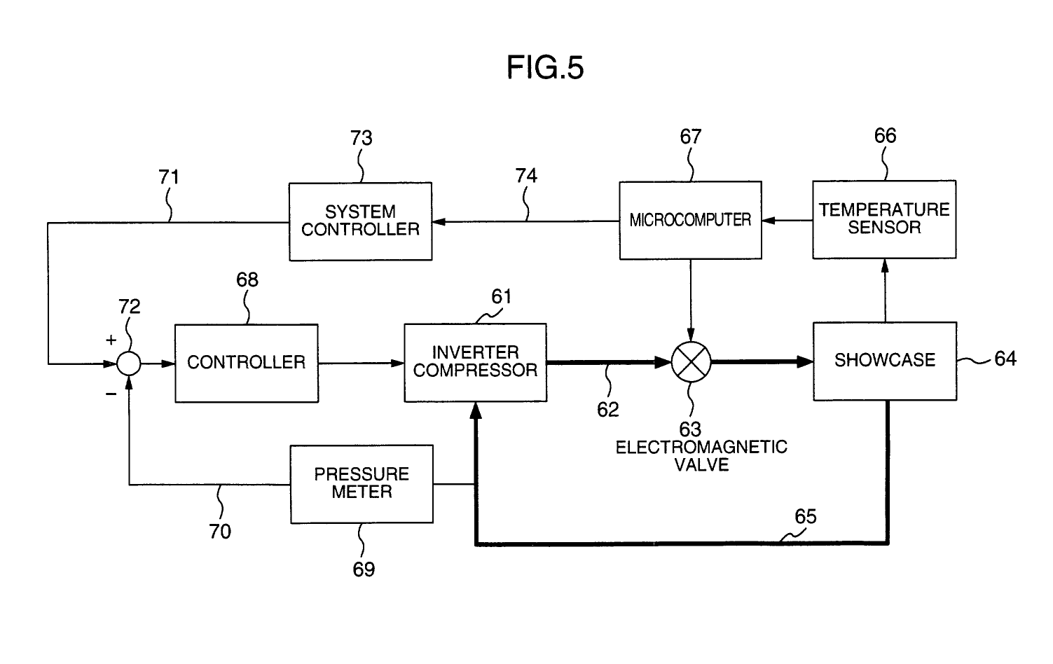

Also, each showcase in the refrigerating showcase group 12 and the freezing showcase group 13 is configured as is illustrated in FIG. 5. Namely, a liquid refrigerant 62 supplied from an inverter compressor 61 is supplied to a heat exchanger of a showcase 64 via an electromagnetic valve 63. In addition, the liquid refrigerant 62 cools down a space inside the showcase 64 and thus becomes a gas refrigerant 65, then being brought back to the inverter compressor 61. The temperature inside the showcase 64 (i.e., the temperature of the space into which foods are to be stored) is measured by a temperature censor 66, then being inputted into a microcomputer 67. Based on the temperature inside the showcase 64, the microcomputer 67 performs an ON/OFF control over the electromagnetic valve 63. A controller 68 determines, by an adder 72, a difference between an absorption pressure 70 of the inverter compressor 61, which is detected by a pressure meter 69, and a set-up value 71 of the absorption pressure 70. Moreover, the controller 68 controls the rotation number of the inverter compressor 61 so that the difference will become smaller, thereby adjusting the freezing capability. Also, based on ON/OFF information 74 on the electromagnetic valve outputted from the microcomputer 67, the set-up value 71 of the absorption pressure is adjusted to the optimum value by a system controller 73. In this way, the set-up value 71 of the absorption pressure is adjusted based on the ON/OFF information 74 on the electromagnetic valve 63. This allows the freezing capability to be appropriately controlled in harmony with a variation in the freezing capability, which accompanies a change in the outside-air temperature between night and daytime. Namely, in comparison with the case of the ordinary inverter compressor that controls the set-up value 71 of the absorption pressure in a state of a fixed value, it becomes possible to implement the energy-saving even further.

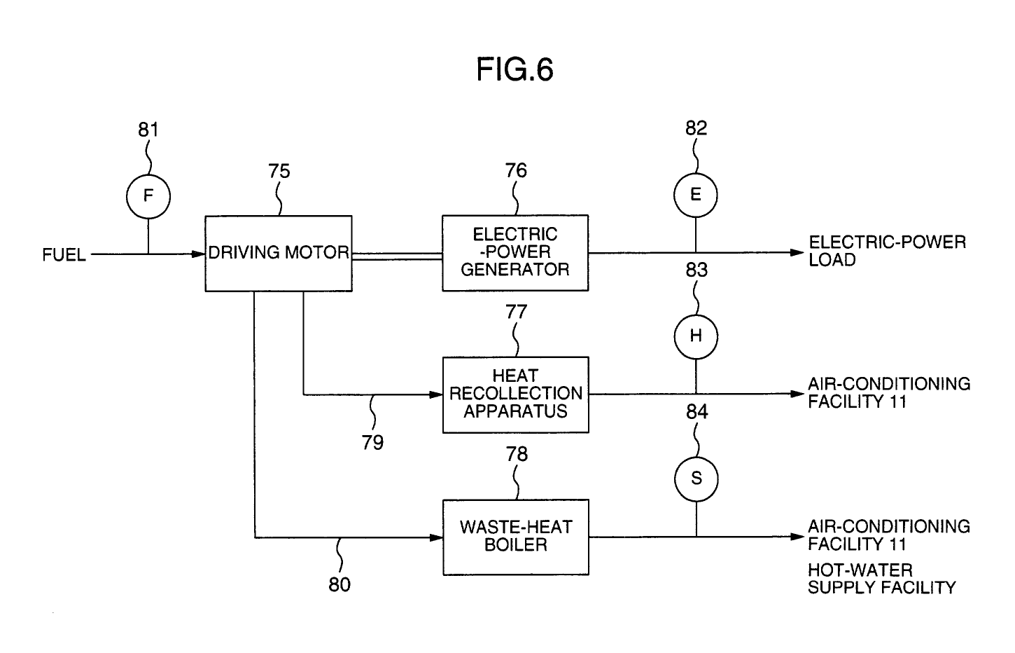

Meanwhile, in the combined electric-power generating facility 14, as illustrated in FIG. 6 for example, a driving motor 75, e.g., an engine, with the supply of a fuel such as a gas or an oil drives an electric-power generator 76 so as to generate electric-power, thereby implementing the averaging or leveling of the electric-power consumption in the daytime and the one at night. In the meantime, a waste heat from the driving motor 75 is recollected by a heat recollection apparatus 77 and a waste-heat boiler 78, thereby being utilized for a hot-water load and a vapor load. As these loads, there exist an air-conditioning and a hot-water supply. The quantity of the fuel is measured by a flow-quantity detector 81, then being recorded into the monitor/control apparatus 18. Similarly, the electric-power generation quantity, the hot-water quantity, and the vapor quantity are measured by an electric-power meter 82, a flow-quantity meter 83, and a flow-quantity meter 84, respectively, then being recorded into the monitor/control apparatus 18.

According to the environmental service system illustrated in FIG. 3 and configured as described above, as will be explained below, the processings at the steps S18 to S21 illustrated in FIG. 1 are executed by the remote information management apparatus 25 with respect to the environmental facilities provided in the supermarket 10.

At first, the remote information management apparatus 25 periodically collects the measurement data necessary for monitoring the state of each appliance of the environmental facilities. The measurement data are periodically collected by the monitor/control apparatuses 15 to 18 of the air-conditioning facility 11, the refrigerating showcase group 12, the freezing showcase group 13, and the combined electric-power generating facility 14. The collected measurement data is transferred to the remote information management apparatus 25 via the communications apparatus 19, the communications network 30, and the communications apparatus 28.

The measurement data includes the following data: The measurement data on the temperature, the humidity, and the like about the quality of environment of the target space defined in the contract, and the measurement data indicating the operation state of each appliance configuring each environmental facility. Also, in addition to the energy quantities such as the electric-power consumption quantity and the fuel quantity of a gas or an oil, the measurement data includes the physical quantities such as the temperature, the heat quantity, and the flow quantity concerned with the energy consumption. Furthermore, the data on the outside-air temperature, humidity, and the like, which exert influences on the energy consumption quantity, are measured and collected as the attribute data together with the measurement data.

The remote information management apparatus 25 stores, into a working memory or a database 26, the measurement data fetched from the communications apparatus 28. Namely, the apparatus fetches periodically (e.g., on a 15-minute to 1-hour basis) the data on the temperature, the humidity, and the like about the quality of environment of the target space defined in the contract, then recording the data into the database 26.

Also, the remote information management apparatus 25 collects the operating data necessary for the maintenance/management business-operations such as the presence or absence of a failure, the carrying-out of the maintenance, and the repairing/improvement, then recording the operating data into the database 26. For example, the apparatus records the measurement data necessary for the diagnosis of each environmental facility, e.g., the electric voltage, the electric current, the flow quantity of the fuel, the flow quantity of a fluid such as the refrigerant, and the temperature. At this time, the apparatus records the simultaneously measured attribute data, e.g., the outside-air temperature and humidity, in a state of being attached to the measurement data. In particular, the apparatus records the measurement data on the energy consumption quantity.

Next, the remote information management apparatus 25 judges whether or not the recorded quality of environment satisfies the guarantee value defined in the contract. If the quality of environment is found to be lower than the guarantee value, the apparatus analyzes the measurement data so as to search for its cause, then performing the checking, maintenance, and improvement of each environmental facility so that the quality of environment will satisfy the guarantee value. These checking, maintenance and improvement may be committed to the maintenance/management center 21 or the service center 22.

When the quality of environment is found to satisfy the contract conditions, the remote information management apparatus 25 transmits an instruction to the charge-billing system 27, thereby causing the system 27 to sum up the consideration defined in the contract. The charge-billing system 27 periodically (e.g., on a 1-month basis, or a 3 to 12-month basis) requests the payment of the consideration. At this time, the apparatus reports, to the client, the quality of environment, the operating situation of each environmental facility, and the energy-saving effect.

Also, the remote information management apparatus 25 can calculate the reduced amount in the energy expense by the energy-saving effect. Furthermore, if the energy reduction amount is included in the subsidiary conditions which defines or prescribes the consideration for the quality of environment, the apparatus judges whether or not the subsidiary or incidental conditions are satisfied. If this judgement is found to be negative, the apparatus analyzes the measurement data so as to search for its cause, then performing the checking, maintenance, and improvement of each environmental facility so that the energy reduction amount will be satisfied.

As having been explained so far, according to the environmental service system illustrated in FIG. 3, it becomes possible to acquire the guarantee that the initial cost and the running cost can be decreased without fail. This condition makes it easier for the client to introduce the environmental facilities that can make contributions to the suppression of the global warming.

In particular, it is guaranteed to maintain the quality of environment, and the client pays the consideration that is commensurate with the guarantee. This condition allows the client to commit or entrust the maintenance/management of the environmental facilities to the environmental service business-entity, thereby permitting the client to save the personnel expense and the like which are necessary for the maintenance/management.

As having been described so far, the present invention is capable of making it easier to introduce an environmental facility that can make a contribution to the suppression of the global warming.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An environmental service system, comprising:
at least one of means for heating a space higher than an outside-air temperature and means for cooling said space lower than an outside-air temperature, said space having been defined between a client and said system, wherein a quality of environment including a temperature of said space, is maintained in a range determined in consultation with said client, a consideration being acquired in correspondence with said maintained quality of environment.

2. The environmental service system as claimed in claim 1, wherein said consideration is determined in correspondence with a contracted temperature of said space and a performance record of energy consumption.

3. The environmental service system as claimed in claim 1, wherein a basic rate of said amount of the consideration is determined based on a contracted temperature of said space and is increased or decreased in correspondence with a difference between a set-up value and a contracted value, said set-up value being set up by said client, as required.

4. The environmental service system as claimed in claim 1, wherein said amount of the consideration is determined in association with a size of said space and a range of a contracted temperature of said space.

5. The environmental service system as claimed in claim 1, wherein said amount of the consideration is determined based on an energy expense needed for maintaining said quality of environment of said space.

6. An environmental service system, comprising:
at least one of means for heating a space higher than an outside-air temperature and means for cooling said space lower than an outside-air temperature, said space having been defined between a client and said system,
means for monitoring a quality of environment including a temperature of said space,
control means for controlling said heating means or said cooling means so as to adjust said quality of environment of said space on a basis of monitor information by said monitoring means and a set-up value of said quality of environment of said space, and
means for judging, on a basis of said monitor information by said monitoring means, whether or not said quality of environment of said space has been maintained in a range determined in consultation with said client, and for calculating a consideration in correspondence with said maintained quality of environment.

7. The environmental service system as claimed in claim 6, wherein, if said set-up value of said quality of environment has been set up outside said range determined in consultation with said client, after a lapse of a constant time-period from said set-up, said control means restores said set-up value of said quality of environment back to within said range determined in consultation with said client.

8. The environmental service system as claimed in claim 7, wherein said set-up value of said quality of environment is of said temperature of said space.

9. The environmental service system as claimed in claim 6, wherein, if a set-up value of said temperature of said space has been set up outside said range determined in consultation with said client, said consideration calculating means increases or decreases said consideration in correspondence with a difference between said set-up value and a contracted value.

10. The environmental service system as claimed in claim 6, wherein said consideration calculating means, which is installed under a management of an environmental service business-entity, is connected to said monitoring means in a communicable manner via a communications network.

11. The environmental service system as claimed in claim 6, wherein at least one of said monitoring means, said heating means, and said cooling means includes communications means, said communications means collecting data on said quality of environment and operation states of said heating means and said cooling means so as to transmit said data to information managing means of an environmental service business-entity via a communications network.

12. The environmental service system as claimed in claim 11, wherein said information managing means has a function of comparing said collected data on said quality of environment and said operation states of said heating means and said cooling means with diagnosis data, and of making diagnosis of said heating means and said cooling means.

13. An environmental service system, comprising:
electric-power generating means, and
at least one of means for heating a target space and means for cooling said target space, wherein a quality of environment including a temperature of said target space, is maintained in a range determined in consultation with a client, a consideration being acquired in correspondence with said maintained quality of environment and an electric-power supply quantity from said electric-power generating means.

14. The environmental service system as claimed in claim 13, wherein said heating means and said cooling means utilize, as an energy source, a waste heat from said electric-power generating means.

15. An environmental service business, comprising the business-operations of:
designing at least one of environmental facilities, said environmental facilities including means for heating a target space higher than an outside-air temperature and means for cooling said target space lower than an outside-air temperature, and
guaranteeing that a quality of environment, including a temperature of said target space, will be maintained in a range determined in consultation with a client.

16. An environmental service business, comprising the business-operations of:
planning at least either of environmental facilities, said environmental facilities including means for heating a target space higher than an outside-air temperature and means for cooling said target space lower than an outside-air temperature,
guaranteeing that a quality of environment including a temperature of said target space, will be maintained in a range determined in consultation with a client, and
acquiring, as a consideration for said guarantee, a part of a reduction amount of a running cost obtained by an energy-saving effect of at least one of said environmental facilities.

17. The environmental service business as claimed in claim 16, wherein an environmental service business-entity collects measurement data on said quality of environment of said target space and working state data on at least either of said environmental facilities, said business-entity then performing, within a range of said consideration, a maintenance/management necessary for maintaining said quality of environment in said range determined in consultation with said client.
